(19) United States
(12) Patent Application Publication
(10) Pub. No.: US 2025/0200845 A1
(43) Pub. Date: Jun. 19, 2025

(54) PSEUDO IMAGE GENERATION DEVICE

(71) Applicant: NTT DOCOMO, INC., Tokyo (JP)

(72) Inventors: Ryosuke MIZUNO, Chiyoda-ku (JP); Takuya KITADE, Chiyoda-ku (JP)

(73) Assignee: NTT DOCOMO, INC., Tokyo (JP)

(21) Appl. No.: 18/844,521

(22) PCT Filed: Feb. 7, 2023
(86) PCT No.: PCT/JP2023/004067

§ 371 Date: Sep. 6, 2024

(30) Foreign Application Priority Data
Mar. 15, 2022 (JP) 2022-039960

(51) Int. Cl. G06T 11/60; G06T 7/11; G06V 20/70

(52) U.S. Cl. CPC G06T 11/60; G06T 7/11; G06V 20/70

(57) ABSTRACT

A pseudo image generation device (10) that generates a pseudo image from foreground image data and background image data includes: a transparentizing processing unit (11) configured to transparentize a region other than an object to be synthesized in a foreground image; a synthesis unit (12) configured to synthesize the background image data and the foreground image data after transparentizing processing such that a foreground image after the transparentizing processing is superimposed on a prescribed position in a background image; a deletion unit (13) configured to delete background annotation data overlapping the object to be synthesized after synthesis from background annotation data included in the background image data and attached within the background image; and a data generation unit (14) configured to generate annotation data of the pseudo image based on the background annotation data after deletion.

### TECHNICAL FIELD

The present disclosure relates to a pseudo image generation device that generates a pseudo image attached with annotation data for use in training or the like of artificial intelligence. The “annotation data” herein means related information (also referred to as “annotation”, “tag”, and “label”) of an object reflected in an image, and is generally synthesized at a neighboring position of the object in the image.

### BACKGROUND ART

In training of artificial intelligence, for example, processing of generating image data attached with annotation data of various plants by synthesizing a name of a plant is synthesized as annotation data with an image in which the plant is reflected, at a neighboring position of the plant in the image, and inputting obtained multiple image data as training data to the artificial intelligence to train the artificial intelligence is executed. The generation of image data attached with annotation data is described in, for example, Patent Literature 1. It is desirable that the training data input to the artificial intelligence to train the artificial intelligence is multiple image data in various forms. For this reason, in many cases, a synthesized image (an image in which a certain object to be synthesized is reflected in the background) obtained by synthesizing a background image in which a background is reflected and a foreground image in which the object to be synthesized is reflected is used as training data.

### CITATION LIST

### Patent Literature

[Patent Literature 1] Japanese Unexamined Patent Publication No. 2006-108813

### SUMMARY OF INVENTION

### Technical Problem

By the way, in the generation of image data attached with annotation data, for an image obtained by imaging only a portion in the whole of a certain image under different conditions, an image obtained by imaging while slightly shifting a position or an angle of a certain image, or the like, annotation data needs to be repeatedly attached even at a point reflected in the same manner as an original image. For this reason, as a processing load in a broad sense including time or labor required for attaching annotation data, time or labor required for data collection in various forms, and a processing load of a computer, a very high processing load is required.

An object of the present disclosure is to reduce a processing load as described above in generating image data attached with annotation data and to generate pseudo image data in multiple forms with a low load.

### Solution to Problem

There is provided a pseudo image generation device according to the present disclosure that generates a pseudo image from foreground image data pertaining a foreground image in which an object to be synthesized is reflected and background image data pertaining to a background image in which a background is reflected, the pseudo image generation device including a transparentizing processing unit configured to transparentize a region other than the object to be synthesized in the foreground image, a synthesis unit configured to synthesize the background image data and the foreground image data after transparentizing processing such that the foreground image after the transparentizing processing in the transparentizing processing unit is superimposed on a prescribed position in the background image, a deletion unit configured to delete background annotation data overlapping the object to be synthesized after synthesis in the synthesis unit from the background annotation data included in the background image data and attached within the background image, and a data generation unit configured to generate annotation data of the pseudo image based on the background annotation data after deletion in the deletion unit.

In the above-described pseudo image generation device, the transparentizing processing unit transparentizes the region other than the object to be synthesized in the foreground image. The “transparentizing processing” herein is processing the region other than the object to be synthesized transparent. Then, the synthesis unit synthesizes the background image data and the foreground image data after the transparentizing processing such that the foreground image after the transparentizing processing is superimposed on the prescribed position in the background image. In the image after synthesis herein, the object to be synthesized is reflected, and the background is reflected in the region other than the object to be synthesized. In addition, the deletion unit deletes the background annotation data overlapping the object to be synthesized after synthesis from the background annotation data included in the background image data and attached within the background image, and the data generation unit generates the annotation data of the pseudo image based on the background annotation data after deletion.

As described above, after the transparentizing processing of the region other than the object to be synthesized in the foreground image and the deletion of the background annotation data overlapping the object to be synthesized after synthesis are performed, the annotation data of the pseudo image is generated. Thus, for an image obtained by imaging only a portion in the whole of a certain image under different conditions, an image obtained by imaging while slightly shifting a position or an angle of a certain image, or the like, annotation data does not need to be repeatedly attached at a place reflected in the same manner as an original image. For this reason, it is possible to reduce a processing load in a broad sense including time or labor required for attaching annotation data, time or labor required for data collection in various forms, and a processing load of a computer, and to generate pseudo image data in various forms with a low load.

### Advantageous Effects of Invention

According to the present disclosure, it is possible to reduce a processing load as described above in generating image data attached with annotation data, and to generate pseudo image data in various forms with a low load.

### BRIEF DESCRIPTION OF DRAWINGS

FIG. 1 is a functional block configuration diagram of a pseudo image generation device in an embodiment of the invention.

FIG. 2 is a flowchart illustrating processing that is executed by the pseudo image generation device.

FIG. 3 is a diagram illustrating processing until synthesis of background image data and foreground image data.

FIG. 4 is a diagram illustrating deletion of background annotation data.

FIG. 5 is a diagram illustrating a hardware configuration example of the pseudo image generation device.

### DESCRIPTION OF EMBODIMENTS

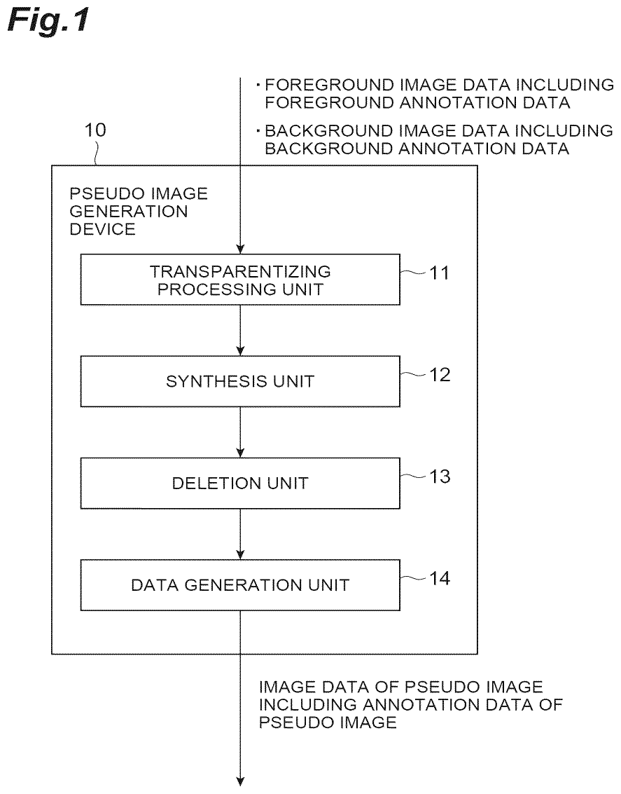

Hereinafter, an embodiment of a pseudo image generation device according to the present disclosure will be described with reference to the drawings. The pseudo image generation device according to the present disclosure is a pseudo image generation device that generates a pseudo image from foreground image data pertaining to a foreground image in which an object to be synthesized is reflected and background image data pertaining to a background image in which a background is reflected, and a configuration example thereof is illustrated in FIG. 1.

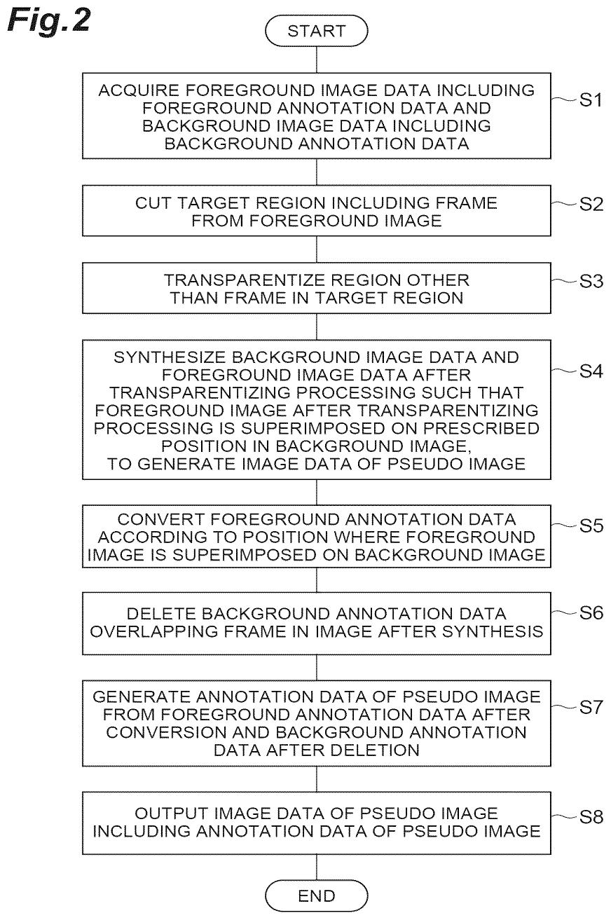

As illustrated in FIG. 1, the pseudo image generation device 10 includes a transparentizing processing unit 11, a synthesis unit 12, a deletion unit 13, and a data generation unit 14. Hereinafter, while functions of the respective units will be schematically described, details will be described below with reference to FIGS. 2 to 4.

The transparentizing processing unit 11 is a functional unit that transparentizes a region other than the object to be synthesized (here, a frame F described below) in the foreground image. In more detail, the transparentizing processing unit 11 cuts a target region including the object to be synthesized from the foreground image and transparentizes the region other than the object to be synthesized in the target region obtained by cutting.

The synthesis unit 12 is a functional unit that synthesizes the background image data and the foreground image data after transparentizing processing such that the foreground image after the transparentizing processing in the transparentizing processing unit 11 is superimposed on the prescribed position in the background image.

The deletion unit 13 is a functional unit that deletes background annotation data overlapping the object to be synthesized after synthesis in the synthesis unit 12 from the background annotation data included in the background image data and attached within the background image, and further has a function of converting the foreground annotation data included in the foreground image data and attached within the foreground image according to a position where the foreground image is superimposed on the background image. For example, the deletion unit 13 converts coordinate information of the object to be synthesized included in the foreground annotation data from coordinates in a coordinate system of the foreground image into coordinates in a coordinate system of the background image.

The data generation unit 14 is a functional unit that generates annotation data of the pseudo image based on the foreground annotation data after conversion and the background annotation data after deletion, and further has a function of outputting image data of the pseudo image including the generated annotation data. The “output” includes outputs in various forms such as display output on a display, print output to a printer, and data transmission to an external device.

Next, processing that is executed in the pseudo image generation device 10 will be described along a flowchart of FIG. 2. For example, the processing of FIG. 2 starts to be executed with a prescribed execution start instruction by an operator of the pseudo image generation device 10 as a trigger.

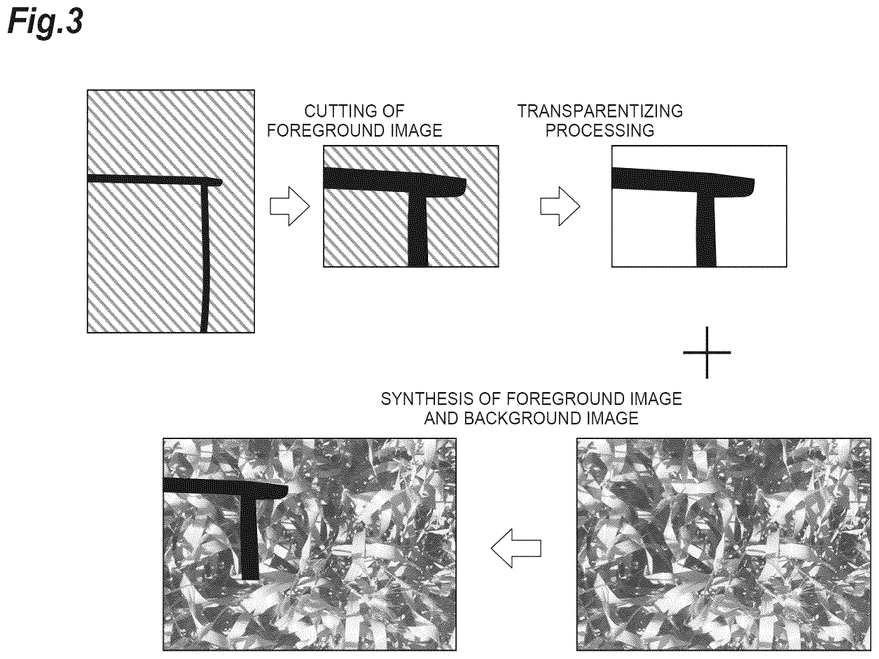

First, the transparentizing processing unit 11 acquires the foreground image data including the foreground annotation data and the background image data including the background annotation data (Step S1), cuts the target region including the frame from the foreground image as illustrated in FIG. 3 (Step S2), and then, transparentizes a region other than the frame in the target region obtained by cutting (Step S3). In regard to data acquisition in Step S1, the above-described data may be acquired by receiving the data from an external device or may be acquired by reading out the data from a database (not shown) stored in the pseudo image generation device 10, and an acquisition method is not limited to a specific method.

Next, the synthesis unit 12 synthesizes the background image data and the foreground image data after the transparentizing processing such that the foreground image after the transparentizing processing is superimposed on the prescribed position in the background image, to generate the image data of the pseudo image (Step S4). In the image after synthesis herein, for example, as illustrated in FIG. 3, an upper right portion of the frame is reflected, and a wheat cultivation field of the background is reflected in the region other than the frame.

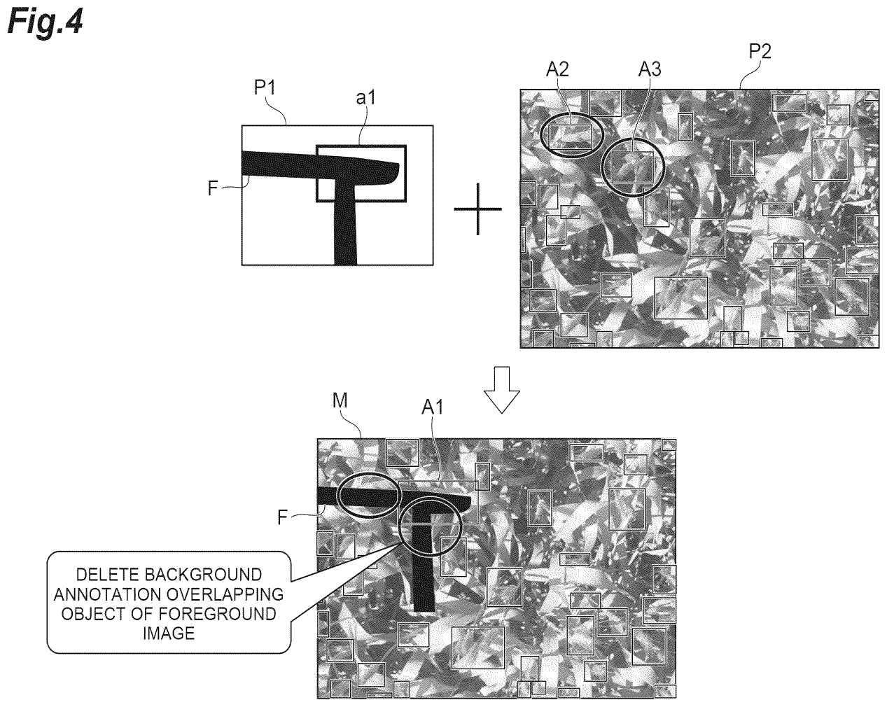

Next, the deletion unit 13 converts the foreground annotation data according to the position where the foreground image is superimposed on the background image (Step S5). Specifically, coordinate information of the frame F included in the foreground annotation data is converted from coordinates in the coordinate system of the foreground image into coordinates in the coordinate system of the background image. For example, while an example where a foreground image P1 and a background image P2 are synthesized to obtain a synthesized image M is illustrated in FIG. 4, the coordinate information of the frame F included in foreground annotation data al is converted from coordinates in the coordinate system of the foreground image into coordinates in the coordinate system of the background image, to obtain foreground annotation data A1 including the converted coordinate information. In FIG. 4, for convenience, annotation data is denoted by a rectangle surrounding a part or the whole of an attached object. Then, the deletion unit 13 deletes background annotation data overlapping the frame in the image after synthesis (Step S6). For example, as illustrated in FIG. 4, background annotation data (that is, background annotation data A2 and A3 in the background image P2 attached to wheat spikes overlapping the frame F) overlapping the frame F in the synthesized image M is deleted.

The data generation unit 14 generates the annotation data of the pseudo image from the foreground annotation data after conversion and the background annotation data after deletion (Step S7). In the synthesized image M of FIG. 4, the foreground annotation data A1 after conversion and the background annotation data after deletion coexist. Thereafter, the data generation unit 14 outputs the image data of the pseudo image including the annotation data of the pseudo image (Step S8).

According to the embodiment described above, after the transparentizing processing of the region other than the object to be synthesized in the foreground image and the deletion of the background annotation data overlapping the object to be synthesized after synthesis are performed, the annotation data of the pseudo image is generated. Thus, for an image obtained by imaging only a portion in the whole of a certain image under different conditions, an image obtained by imaging while slightly shifting a position or an angle of a certain image, or the like, annotation data does not need to be repeatedly attached at a place reflected in the same manner as an original image. For this reason, it is possible to reduce a processing load in a broad sense including time or labor required for attaching annotation data, time or labor required for data collection in various forms, and a processing load of a computer, and to generate pseudo image data in various forms with a low load.

According to the embodiment as described above, since it is possible to freely synthesize foreground images in which various objects to be synthesized are reflected and background images in which various backgrounds are reflected, along with annotation data thereof with a low load, it is possible to generate pseudo image data in various forms including synthesized images representing states that are impossible or occurs rarely in the real world, with a low load, and to achieve both a reduction in processing load and enhancement of image diversity in training data generation to be a premise of the training of the artificial intelligence. For example, in synthesizing six kinds of background image data attached with annotation data and six kinds of foreground image data attached with annotation data, it is not necessary to repeatedly attach background/foreground annotation data to each of 36 synthesized images in total, and it is possible to obtain 36 synthesized images in total by merely executing processing with a low load such as deletion of part of the background annotation data overlapping the object to be synthesized (frame F) and conversion of the foreground annotation data, and to achieve both a reduction in processing load and enhancement of image diversity in training data generation.

In Step S2 of FIG. 2, while an example where the target region including the object to be synthesized (frame F) is cut from the foreground image has been described, such cutting processing is not essential, and for example, in a case where the target region including the object to be synthesized (frame F) corresponds to the entire foreground image, the cutting processing is not required.

The foreground image does not necessarily have annotation data. For example, the present disclosure can also be applied to a case where a foreground image with no annotation data is synthesized with a background image attached with background annotation data, and similar effects are obtained.

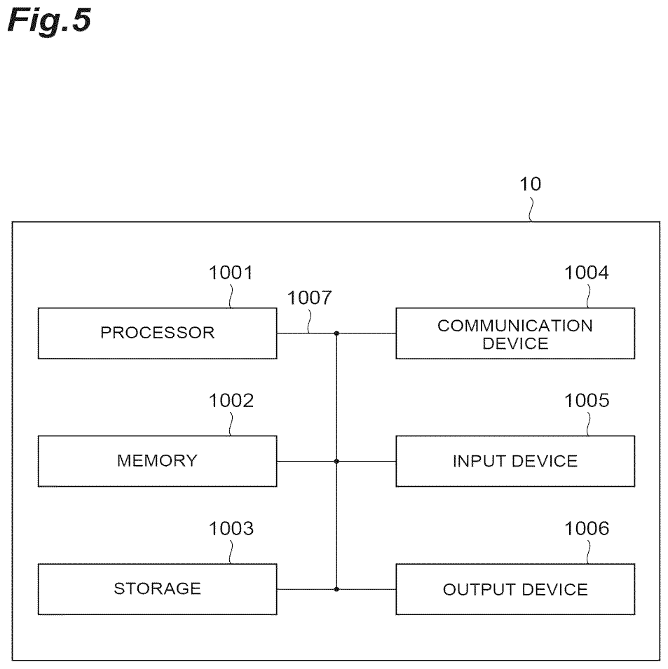

### (Description of Terms, Description of Hardware Configuration (FIG. 5), and the Like)

The block diagram used to describe the above-described embodiment and the modification examples illustrates blocks in units of functions. These functional blocks (constituent units) are implemented in any combination of at least one of hardware and software. Also, the implementation method of each functional block is not particularly limited. That is, each functional block may be implemented using one device combined physically or logically or may be implemented by directly or indirectly connecting two or more devices separated physically or logically (for example, in a wired or wireless manner) and using the plurality of devices. The functional blocks may be implemented by combining software with one device or the plurality of devices.

The functions include determining, deciding, judging, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like, but are not limited thereto. For example, a functional block (configuration unit) that causes transmitting is referred to as a transmitting unit or a transmitter. In any case, as described above, the implementation method is not particularly limited.

For example, the pseudo image generation device in an embodiment of the present disclosure may function as a computer that executes processing in the present embodiment. FIG. 5 is a diagram illustrating a hardware configuration example of the pseudo image generation device 10 according to the embodiment of the present disclosure. The above-described pseudo image generation device 10 may be physically configured as a computer device including a processor 1001, a memory 1002, a storage 1003, a communication device 1004, an input device 1005, an output device 1006, a bus 1007, and the like.

In the following description, the term “device” can be replaced with a circuit, a device, a unit, or the like. The hardware configuration of the pseudo image generation device 10 may be configured to include one or a plurality of devices among the devices illustrated in the drawing or may be configured without including part of the devices.

Each function in the pseudo image generation device 10 is implemented by having the processor 1001 perform an arithmetic operation by reading prescribed software (program) on hardware such as the processor 1001 and the memory 1002, and control communication by the communication device 1004 or at least one of reading and writing of data in the memory 1002 and the storage 1003.

The processor 1001 operates, for example, an operating system to control the entire computer. The processor 1001 may be configured with a central processing unit (CPU) including an interface with peripheral devices, a control device, an arithmetic device, a register, and the like.

The processor 1001 reads a program (program code), a software module, data, and the like from at least one of the storage 1003 and the communication device 1004 to the memory 1002 and executes various kinds of processing according to the program, the software module, data, and the like. As the program, a program that causes the computer to execute at least a part of the operations described in the above-described embodiment is used. Although the description has been made that various kinds of processing described above are executed by one processor 1001, various kinds of processing may be executed simultaneously or sequentially by two or more processors 1001. The processor 1001 may be implemented by one or more chips. The program may be transmitted from the network via a telecommunication line.

The memory 1002 is a computer-readable recording medium, and may be configured with at least one of, for example, a read only memory (ROM), an erasable programmable ROM (EPROM), an electrically erasable programmable ROM (EEPROM), and a random access memory (RAM). The memory 1002 may be referred to as a register, a cache, a main memory (main storage device), or the like. The memory 1002 can store a program (program code), a software module, or the like that is executable to perform a wireless communication method according to an embodiment of the present invention.

The storage 1003 is a computer-readable recording medium, and may be configured with at least one of, for example, an optical disc such as a compact disc ROM (CD-ROM), a hard disk drive, a flexible disk, a magneto-optical disk (for example, a compact disk, a digital versatile disk, or a Blu-ray (Registered Trademark) disk), a smart card, a flash memory (for example, a card, a stick, or a key drive), a Floppy (Registered Trademark) disk, and a magnetic strip. The storage 1003 may be referred to as an auxiliary storage device. The above-described storage medium may be, for example, a database including at least one of the memory 1002 and the storage 1003 or other appropriate mediums.

The communication device 1004 is hardware (transmission and reception device) that is provided to perform communication between computers via at least one of a wired network and a wireless network, and is also referred to as, for example, a network device, a network controller, a network card, or a communication module.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs an output to the outside. The input device 1005 and the output device 1006 may be integrated (for example, a touch panel). The devices such as the processor 1001 and the memory 1002 are connected by the bus 1007 that is provided to communicate information. The bus 1007 may be configured using a single bus or may be configured using different buses between devices.

Each aspect/embodiment described in the present disclosure may be used alone, may be used in combination, or may be switched according to implementation. Furthermore, notification of predetermined information (for example, notification of “being X”) is not limited to explicit notification, but may be performed by implicit notification (for example, not performing notification of the predetermined information).

While the present disclosure has been described above in detail, it will be apparent to those skilled in the art that the present disclosure is not limited to the embodiments described in the present disclosure. The present disclosure may be implemented as modified and changed aspects without departing from the spirit and scope of the present disclosure defined by the description in the claims. Therefore, the description in the present disclosure is for illustration and does not have any restrictive meaning with respect to the present disclosure.

A process procedure, a sequence, a flowchart, and the like in each aspect/embodiment described in the present disclosure may be in a different order unless inconsistency arises. For example, for the method described in the present disclosure, elements of various steps are presented using an exemplary order, and the elements are not limited to the presented specific order.

Input or output information or the like may be stored in a specific place (for example, a memory) or may be managed using a management table. Information or the like to be input or output can be overwritten, updated, or additionally written. Output information or the like may be deleted. Input information or the like may be transmitted to another device.

The expression “based on” used in the present disclosure does not mean “based on only” unless otherwise described. In other words, the expression “based on” means both “based on only” and “based on at least”.

In the present disclosure, in a case where the terms “include”, “including”, and modifications thereof are used, these terms are intended to be comprehensive similarly to the term “comprising”. In addition, the term “or” used in the present disclosure is intended not to be an exclusive OR.

In the present disclosure, for example, in a case where an article such as “a”, “an”, or “the” in English is added through translation, the present disclosure may include a case where a noun following the article is of a plural form.

In the present disclosure, the term “A and B are different” may mean that “A and B are different from each other”. This term may mean that “each of A and B is different from C”. Terms “separate” and “coupled” may also be interpreted in a similar manner to “different”.

### REFERENCE SIGNS LIST

10: Pseudo image generation device, 11: Transparentizing processing unit, 12: Synthesis unit, 13: Deletion unit, 14: Data generation unit, 1001: Processor, 1002: Memory, 1003: Storage, 1004: Communication Device, 1005: Input device, 1006: Output device, 1007: Bus.

1. A pseudo image generation device that generates a pseudo image from foreground image data pertaining to a foreground image in which an object to be synthesized is reflected and background image data pertaining to a background image in which a background is reflected, the pseudo image generation device comprising:
a transparentizing processing unit configured to transparentize a region other than the object to be synthesized in the foreground image;
a synthesis unit configured to synthesize the background image data and the foreground image data after transparentizing processing such that the foreground image after the transparentizing processing in the transparentizing processing unit is superimposed on a prescribed position in the background image;
a deletion unit configured to delete background annotation data overlapping the object to be synthesized after synthesis in the synthesis unit from the background annotation data included in the background image data and attached within the background image; and
a data generation unit configured to generate annotation data of the pseudo image based on the background annotation data after deletion in the deletion unit.

2. The pseudo image generation device according to claim 1, wherein the deletion unit further converts foreground annotation data included in the foreground image data and attached within the foreground image according to a position where the foreground image is superimposed on the background image, and
the data generation unit generates the annotation data of the pseudo image based on the foreground annotation data after conversion and the background annotation data after deletion.

3. The pseudo image generation device according to claim 1, wherein the transparentizing processing unit is configured to cut a target region including the object to be synthesized in the foreground image from the foreground image and transparentize a region other than the object to be synthesized in the target region obtained by cutting.

4. The pseudo image generation device according to claim 2, wherein the transparentizing processing unit is configured to cut a target region including the object to be synthesized in the foreground image from the foreground image and transparentize a region other than the object to be synthesized in the target region obtained by cutting.
